(19) United States
(12) Patent Application Publication
(10) Pub. No.: US 2020/0301635 A1
(43) Pub. Date: Sep. 24, 2020

(54) INFORMATION PROCESSING SYSTEM, IMAGE PROCESSING APPARATUS, AND NON-TRANSITORY COMPUTER READABLE MEDIUM

(71) Applicant: FUJI XEROX CO., LTD., Tokyo (JP)

(72) Inventor: Hirofumi OGAWA, Kanagawa (JP)

(73) Assignee: FUJI XEROX CO., LTD., Tokyo (JP)

(21) Appl. No.: 16/534,647

(22) Filed: Aug. 7, 2019

(30) Foreign Application Priority Data
Mar. 18, 2019 (JP) 2019-049554

(51) Int. Cl. G06F 3/12

(52) U.S. Cl. CPC G06F 3/1254; G06F 3/1271; G06F 3/1205

(57) ABSTRACT

An information processing system includes information and image processing apparatuses. The information processing apparatus includes a receiving unit receiving a print setting, a print job transmitting unit transmitting to the image processing apparatus a print job reflecting the setting, a prohibition determination job transmitting unit transmitting to the image processing apparatus a prohibition determination job reflecting the setting, and a controller performing control such that the print job reflecting the setting is not transmitted if the setting reflected in the prohibition determination job transmitted by the prohibition determination job transmitting unit is determined to be in a non-printable status. The image processing apparatus includes an output unit executing the print job from the information processing apparatus, and a determination unit determining in response to the prohibition determination job from the information processing apparatus whether the print setting reflected in the prohibition determination job is in a printable status.

### CROSS-REFERENCE TO RELATED APPLICATIONS

This application is based on and claims priority under 35 USC 119 from Japanese Patent Application No. 2019-049554 filed Mar. 18, 2019.

### BACKGROUND

### (i) Technical Field

The present disclosure relates to an information processing system, an image processing apparatus, and a non-transitory computer readable medium.

### (ii) Related Art

Japanese Unexamined Patent Application Publication No. 2009-163574 discloses a technique that is directed to performing a conflict process more accurately than in the related art. According to the disclosure, a print setting suffers from device conflict on a network printer side when a print operation is being performed. A device conflict rule is stored on a device conflict rule database (DB). Whether a conflict is triggered or not is determined by using the device conflict rule stored on the device conflict rule DB in addition to a conflict rule registered on a conflict rule DB (in a system). A record of the print setting that has failed is analyzed and then stored as the device conflict. A determination accuracy of determining whether a conflict is triggered is thus increased than in the related art.

Japanese Unexamined Patent Application Publication No. 2001-134388 discloses a technique that is directed to providing a print job monitoring method that quickly notifies a user of a setting error if a print condition transmitted to a printer has the setting error. A print job (including a set print condition) transmitted from a personal computer to the printer is also sent to a central processing unit (CPU) of the personal computer. Based on a determination table, the CPU determines whether the set print condition is executable on the printer. If the CPU determines that the set print condition is not executable, the CPU displays on a display screen of the personal computer a message indicating that the set print condition is not executable.

One printer driver of the related art may control multiple types of image processing apparatuses that are different from each other in terms of functions available and the type of paper sheets to be used. The printer driver may not necessarily reflect information, for example, information about a prohibition rule of an image processing apparatus that becomes commercially available after the introduction of the printer driver in the market. The information may include information on a function that is not available on the image processing apparatus and a type and size of a paper sheet that are not usable on the image processing apparatus, and information on a combination of such function and type and size of the paper sheet. If a print job reflecting a print setting related to such a prohibition rule is received, the image processing apparatus is not able to correctly perform the print job.

### SUMMARY

Aspects of non-limiting embodiments of the present disclosure relate to providing an image processing system that controls the transmission of a print job reflecting a print setting related to a prohibition rule to an image processing apparatus without storing information related to the prohibition rule of the image processing apparatus serving as a control target. Aspects of non-limiting embodiments of the present disclosure also relate to providing an information processing apparatus and a non-transitory computer readable medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system. The information processing system includes an information processing apparatus and an image processing apparatus. The information processing apparatus includes a receiving unit that receives a print setting, a print job transmitting unit that, in response to a print execution instruction from a user, transmits to the image processing apparatus a print job that reflects the print setting, a prohibition determination job transmitting unit that transmits to the image processing apparatus a prohibition determination job that reflects the print setting, and a controller that performs control such that the print job reflecting the print setting is not transmitted if the print setting reflected in the prohibition determination job transmitted by the prohibition determination job transmitting unit is determined to be in a non-printable status. The image processing apparatus includes an output unit that executes the print job received from the information processing apparatus and a determination unit that determines in response to the prohibition determination job received from the information processing apparatus whether the print setting reflected in the prohibition determination job is in a printable status.

### BRIEF DESCRIPTION OF THE DRAWINGS

Exemplary embodiment of the present disclosure will be described in detail based on the following figures, wherein:

FIG. 1 illustrates a modular configuration of an information processing system of an exemplary embodiment;

FIGS. 2A through 2C2 illustrate configurations of printer drivers;

FIG. 3 illustrates a specific modular configuration of the exemplary embodiment;

FIG. 4 is a flowchart illustrating a process of the exemplary embodiment;

FIGS. 5A through 5C illustrate on-screen display examples related to a print setting of the exemplary embodiment;

FIGS. 6A and 6B illustrate a data structure of prohibition determination job information and print job information;

FIG. 7 illustrates a data structure in a print and prohibition determination job log table;

FIG. 8 illustrates a data structure in prohibition determination result information;

FIG. 9 illustrates a display example of prohibition determination results of the exemplary embodiment;

FIG. 10 is a flowchart illustrating a process of the exemplary embodiment;

FIGS. 11A and 11B illustrate on-screen display examples of a job log of the exemplary embodiment; and

FIG. 12 is a block diagram illustrating a hardware configuration of a computer that implements the exemplary embodiment.

### DETAILED DESCRIPTION

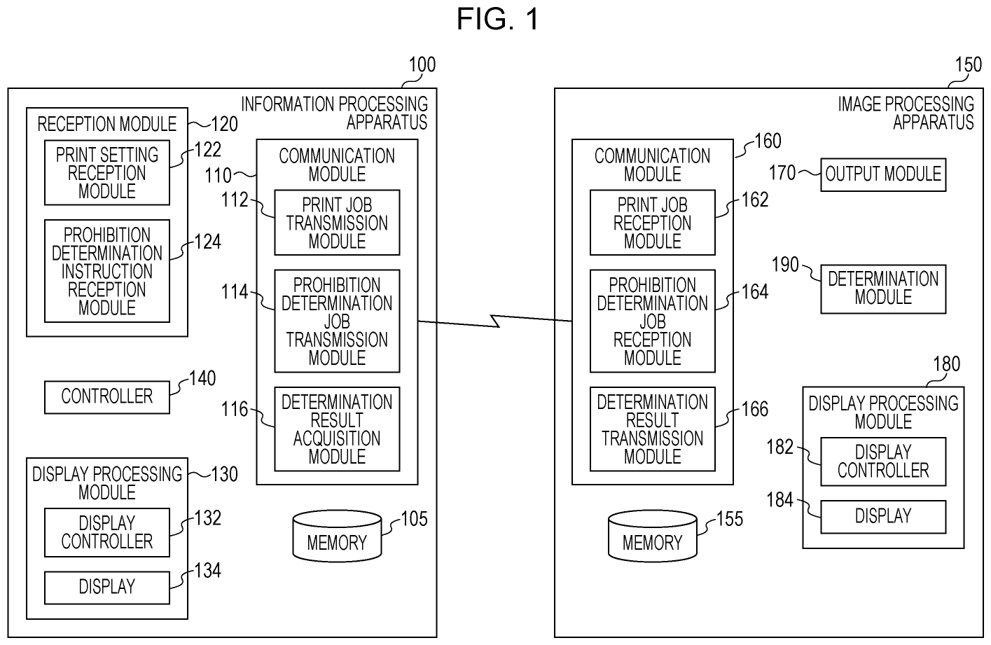

Exemplary embodiment of the disclosure is described with reference to the drawings. FIG. 1 illustrates a modular configuration of an information processing system of the exemplary embodiment.

The term “module” refers to a software component (including a computer program) that is logically separable, or a hardware component. The module of the exemplary embodiment refers to not only a module in a computer program but also a module in a hardware configuration. The discussion of the exemplary embodiment also serves as the discussion of computer programs for causing the modules to function (including a program that causes a computer to execute each step, a program that causes the computer to function as an element, and a program that causes the computer to implement each function), a system and a method. In the discussion that follows, the phrases “stores information,” “causes information to be stored,” and other phrases equivalent thereto are used. If the exemplary embodiment is a computer program, these phrases are intended to express “causes a memory device to store information” or “controls a memory device to cause the memory device to store information.” The modules may correspond to the functions in a one-to-one correspondence. In software implementation, one module may be composed of one program or multiple modules may be composed of one program. One module may be composed of multiple programs. Multiple modules may be executed by a single computer. A single module may be executed by multiple computers in a distributed environment or a parallel environment. One module may include another module. In the discussion that follows, the term “connection” refers to not only a physical connection but also a logical connection (such as an exchange of data, instructions, data reference relationship, or login). The term “predetermined” means that something is decided in advance of a process of interest. The term predetermined is thus intended to refer to something that is decided in advance of a process of interest in the exemplary embodiment. Even after a process in the exemplary embodiment has started, the term predetermined refers to something that is decided in advance of a process of interest depending on a condition or a status of the exemplary embodiment at the present point of time or depending on a condition or status of the exemplary embodiment heretofore continuing down to the present point of time. If plural predetermined values are used, the predetermined values may be different from each other, or two or more of the predetermined values (including all the values) may be equal to each other. A statement that “if A, B is to be performed” is intended to mean that it is determined whether something is A, and that if something is determined as A, an action B is to be taken. The statement becomes meaningless if the determination as to whether something is A is not performed. If a discussion is made of events “A, B, and C”, the events “A, B, and C” are quoted as an exemplary purpose only unless otherwise noted. For example, something is applicable to the case in which only the event A is selected.

The term “system” and the term “apparatus” refer to an arrangement where multiple computers, a hardware configuration, and an apparatus are interconnected via a communication network (including a one-to-one communication connection). The term system and the term apparatus also refer to an arrangement that includes a single computer, a hardware configuration, and an apparatus. The term system and the term apparatus have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process result is written onto the memory device. A description related to the reading of the information from the memory device prior to the process and the writing of the processed information onto the memory device subsequent to the process may be omitted as appropriate. The memory devices may include a hard disk, a random-access memory (RAM), an external storage medium, a memory device connected via a communication network, and a register within a central processing unit (CPU).

An image processing system of the exemplary embodiment including an information processing apparatus 100 and an image processing apparatus 150 has a print function. The image processing apparatus 150 performs printing in response to a print execution instruction from the information processing apparatus 100. The information processing apparatus 100 does not have information related to a prohibition rule of the image processing apparatus 150 serving as a control target. In such a case, the information processing apparatus 100 is designed to restrict the transmission of a print job reflecting a print setting related to the prohibition rule to the image processing apparatus 150. The “print job reflecting the print setting related to the prohibition rule” refers to a print job that is related to the prohibition rule and is not performed.

The prohibition or prohibition rule refers to a print setting in which a function or a paper sheet not used on the image processing apparatus 150 or a combination of a function and a paper sheet not used on the image processing apparatus 150. For example, on a particular model of the image processing apparatus 150, a print operation on a paper sheet having a sheet size of A5 and a stapler operation may be individually performed, but the stapler operation on a paper sheet having a sheet size A5 may not be performed. In such a case, the prohibition rule refers to a combination of a setting of the sheet size A5 and the stapler operation.

“Prohibition determination” refers to determining whether the print setting is related to the prohibition rule. For example, if the print setting is related to the combination of the setting of the size A5 sheet paper and the stapler operation, the print operation is determined to be in a non-printable status.

A “prohibition determination job” is performed by the image processing apparatus 150 for the prohibition determination. The prohibition determination job reflects the print setting but is not performed by the image processing apparatus 150. To differentiate the prohibition determination job from the print job, information indicating the prohibition determination job may be included in print job. Image information may or may not be included in the prohibition determination job. From the standpoint of the size of the prohibition determination job, the image information is desirably excluded from the prohibition determination job.

The information processing apparatus 100 includes a memory 105, communication module 110, reception module 120, display processing module 130, and controller 140. The information processing apparatus 100 transmits a print job to the image processing apparatus 150. The information processing apparatus 100 also transmits the prohibition determination job to the image processing apparatus 150. The information processing apparatus 100 may be a personal computer operated by a user or a mobile information communication apparatus (such as mobile phone, smart phone, mobile device, or wearable computer).

The communication module 110 includes a print job transmission module 112, prohibition determination job transmission module 114, and determination result acquisition module 116. The communication module 110 is connected to a communication module 160 in the image processing apparatus 150 via a communication network. The communication module 110 communicates with the image processing apparatus 150.

In response to a print execution instruction from a user, the print job transmission module 112 transmits to the image processing apparatus 150 a print job reflecting a print setting received by a print setting reception module 122.

The prohibition determination job transmission module 114 transmits to the image processing apparatus 150 the prohibition determination job that reflects the print setting received by the print setting reception module 122.

When the print setting reception module 122 receives the print setting, the prohibition determination job transmission module 114 transmits the prohibition determination job reflecting the print setting to the image processing apparatus 150.

Each time the print setting reception module 122 receives the print setting, the prohibition determination job transmission module 114 may transmit the prohibition determination job reflecting the print setting to the image processing apparatus 150.

The determination result acquisition module 116 receives from the image processing apparatus 150 a determination result of the determination module 190. For example, the determination result acquisition module 116 may read the determination result of the determination module 190 stored on a determination result transmission module 166 or may receive the determination result transmitted from the determination result transmission module 166.

The reception module 120 includes the print setting reception module 122 and prohibition determination instruction reception module 124. For example, the reception module 120 receives an operation of the user by controlling a liquid-crystal display that also serves as a touch panel. The reception module 120 may also receive the operation of the user who has operated a mouse, keyboard, camera, and/or microphone. The operation of the user may include the visual line, gesture, and/or voice of the user.

The print setting reception module 122 receives the print setting. For example, the print setting reception module 122 receives the print setting in response to the operation of the user. The prohibition determination instruction reception module 124 receives a prohibition determination instruction from the user.

The display processing module 130 includes a display controller 132 and a display 134. The display processing module 130 displays a message to the user by controlling the liquid-crystal display serving as the touch panel. The message to the user may also be provided via an audio output from a speaker or tactile feeling on a tactile device.

If the image processing apparatus 150 determines that the print job is in a non-printable status, the display controller 132 controls the display 134 to display an indication indicating that the print job is in a non-printable status.

If the prohibition determination instruction reception module 124 receives the prohibition determination instruction, the display controller 132 may perform control to transmit the prohibition determination job reflecting the print setting to the image processing apparatus 150 and to cause the display 134 to display an indication based on the determination result responsive to the prohibition determination job.

Even if the print setting reception module 122 commands the print job to be performed and the image processing apparatus 150 determines that the prohibition determination job reflecting the print setting at the time of the print execution instruction is in a non-printable status, the display controller 132 may perform control such that the display 134 displays an indication indicating that the print job is in a non-printable status.

Even if the print execution instruction is not provided and the image processing apparatus 150 determines that the prohibition determination job transmitted from the prohibition determination job transmission module 114 is in a non-printable status, the display controller 132 may control the display 134 such that the display 134 does not display the indication indicating that the print job is in a non-printable status. For example, each time the print setting is received, the prohibition determination job reflecting the print setting is transmitted to the image processing apparatus 150. Even if the image processing apparatus 150 determines that the print setting is in a non-printable status, the indication indicating that the print job is in a non-printable status is not displayed until the print execution instruction is provided.

The display 134 performs a display operation under the control of the display controller 132. For example, the display 134 is a liquid-crystal display serving as a touch panel, an organic electroluminescence (EL) display, or the like.

If the image processing apparatus 150 determines that the print setting reflected in the prohibition determination job transmitted from the prohibition determination job transmission module 114 is in a non-printable status, the controller 140 performs control such that the print job reflecting the print setting is not transmitted to the image processing apparatus 150.

If the print execution instruction has been provided by the user, the controller 140 causes the prohibition determination job transmission module 114 to transmit the prohibition determination job prior to the transmission of the print job reflecting the print setting. If the image processing apparatus 150 determines that the print job is in a printable status, the controller 140 performs control such that the print job reflecting the print setting is transmitted to the image processing apparatus 150.

The memory 105 stores a combination of the print setting reflected in the transmitted prohibition determination job and determination result.

Based on the determination result stored on the memory 105, the print setting reception module 122 may deny the reception of the print setting that is in a non-printable status. In the denial of the reception of the print settings in a combination, a print setting determined to be in a non-printable status may be hidden or grayed out such that the print setting is not selected.

The image processing apparatus 150 includes a memory 155, communication module 160, output module 170, display processing module 180, and determination module 190. The image processing apparatus 150 performs a print operation in response to the print job received from the information processing apparatus 100. For example, the image processing apparatus 150 may be a printer or a multi-function apparatus. For example, the multi-function apparatus may be an image processing apparatus that has at least two or more functions a scanner, printer, copying machine, and facsimile machine. By using the prohibition determination job received from the information processing apparatus 100, the image processing apparatus 150 also determines whether the print setting reflected in the prohibition determination job is printable.

The communication module 160 includes a print job reception module 162, prohibition determination job reception module 164, and determination result transmission module 166. The communication module 160 is connected to the communication module 110 in the information processing apparatus 100 via the communication network. The communication module 160 communicates with the information processing apparatus 100.

The print job reception module 162 receives a print job from the information processing apparatus 100. Specifically, the print job reception module 162 receives the print job from the print job transmission module 112 in the information processing apparatus 100.

The prohibition determination job reception module 164 receives a prohibition determination job from the information processing apparatus 100. Specifically, the prohibition determination job reception module 164 receives the prohibition determination job from the prohibition determination job transmission module 114 in the information processing apparatus 100.

The determination result transmission module 166 causes the information processing apparatus 100 to acquire the determination result of the determination module 190. For example, the determination result transmission module 166 may store the determination result of the determination module 190 such that the determination result acquisition module 116 in the information processing apparatus 100 is enabled to read the determination result or the determination result transmission module 166 may transmit the determination result to the information processing apparatus 100.

The output module 170 performs the print job received from the information processing apparatus 100. Specifically, the output module 170 prints an image included in the print job in accordance with the print setting included in the print job.

The display processing module 180 includes a display controller 182 and a display 184. The display processing module 180 displays a log, such as a print job, to the user by controlling the liquid-crystal display. The message to the user may also be provided via an audio output from a speaker or tactile feeling on a tactile device.

The display controller 182 may perform control, causing the display 184 to display information related to the print job stored on the memory 155.

The display controller 182 may further perform control to display information related to the print job separately from information related to the prohibition determination job.

The display controller 182 may also perform control to display on the display 184 information related to the print job stored on the memory 155.

The display controller 182 may perform control such that the information related to the print job is displayed but the information related to the prohibition determination job is not displayed.

The display 184 performs the display operation under the control of the display controller 182. For example, the display 184 may be a liquid-crystal display or an organic EL display. The display 184 may be included in the image processing apparatus 150. Alternatively, the information to be displayed on the display 184 may be transmitted to the information processing apparatus 100 via the communication network and displayed on the display 134 in the information processing apparatus 100. In such a case, a web page may be generated and displayed via a web browser of the information processing apparatus 100.

The memory 155 stores the print job received from the information processing apparatus 100. The memory 155 may store the print setting of the prohibition determination job received from the information processing apparatus 100 and the determination result responsive to the prohibition determination job. The “determination result” is obtained by the determination module 190 and indicates whether the print job is in a printable status.

Based on the prohibition determination job received from the information processing apparatus 100, the determination module 190 determines whether the print setting reflected in the prohibition determination job is in a printable status. The determination module 190 may simply determine whether the image processing apparatus 150 is able to perform the print operation in accordance with the print setting included in the prohibition determination job. Specifically, the determination module 190 stores the prohibition rule and if the print setting falls within the prohibition rule, the determination module 190 determines that the print job is in a non-printable status. Conversely, a condition under which the image processing apparatus 150 is enabled to perform the print operation is stored, and if the print setting does not satisfy the condition, the determination module 190 determines that the print job is in a non-printable status.

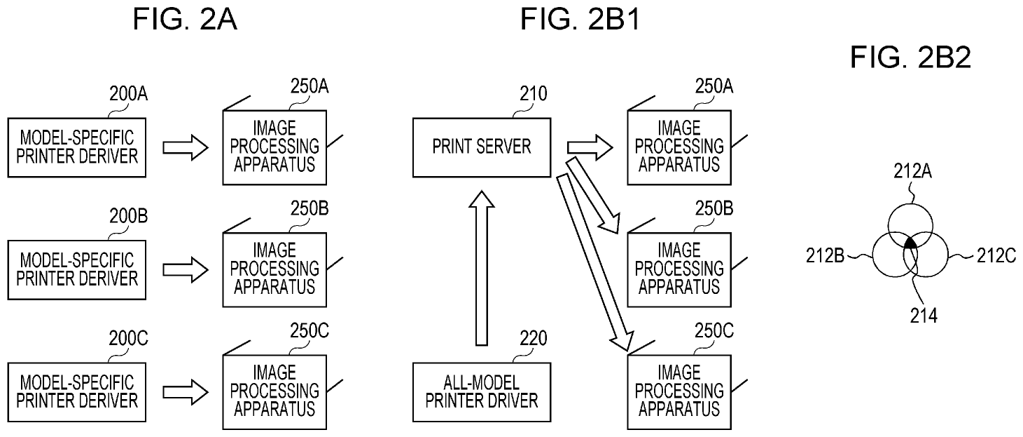

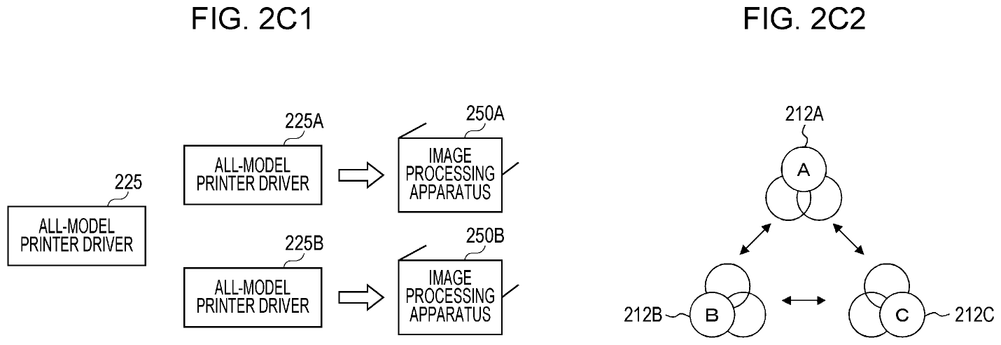

FIGS. 2A through 2E illustrate configurations of printer drivers. In a typical print operation performed on the image processing apparatus, a printer driver specific to the model of the image processing apparatus is installed onto a user terminal. FIG. 2A illustrates an example of such a process. The image processing apparatuses 250A through 250C are different in model. A model-specific printer driver 200A has been developed for the image processing apparatus 250A, a model-specific printer driver 200B has been developed for the image processing apparatus 250B, and a model-specific printer driver 200C has been developed for the image processing apparatus 250C.

Since installing printer drivers respectively for image processing apparatuses 250 on a user terminal is time consuming, a printer driver common to several models is supplied. FIG. 2B1 illustrates such an example. An all-model printer driver 220 is installed on the print server 210 and the print server 210 may perform the print operation using the image processing apparatuses 250A, 250B, and 250C.

The all-model printer driver 220 supports only functions that are supported by almost all of the models of image processing apparatus 250 such that the all-model printer driver 220 is used on almost all of the models of the image processing apparatus 250. Venn diagram in FIG. 2B2 illustrates this operation. Model A support function 212A denotes a function region of the image processing apparatus 250A, model B support function 212B denotes a function region of the image processing apparatus 250B, and model C support function 212C denotes a function region of the image processing apparatus 250C. All model support function 214 where all three function regions overlap denotes a function region supported by the all-model printer driver 220.

FIG. 2C1 illustrates an all-model printer driver 225. The all-model printer driver 225 supports the functions of all the models of the image processing apparatuses 250. The image processing apparatus 250 serving as a connection destination switches the functions. Specifically, the all-model printer driver 225 is installed on a user terminal. If the image processing apparatus 250A is connected to the user terminal, the all-model printer driver 225 operates as the all-model printer driver 225A that fulfills the functions of the image processing apparatus 250A. If the image processing apparatus 250B is connected, the all-model printer driver 225 operates as the all-model printer driver 225B that fulfills the functions of the image processing apparatus 250B. Venn diagram in FIG. 2C2 illustrates this operation. The all-model printer driver 225 supports the three function regions of the model A support function 212A, the model B support function 212B, and the model C support function 212C. If the connection destination is the image processing apparatus 250A, the all-model printer driver 225 operates as a printer driver that supports the region of the model A support function 212A. If the connection destination is the image processing apparatus 250B, the all-model printer driver 225 operates as a printer driver that supports the region of the model B support function 212B. If the connection destination is the image processing apparatus 250C, the all-model printer driver 225 operates as a printer driver that supports the region of the model C support function 212C.

The all-model printer driver may support the functions and prohibition rule of the models that are commercially available when the all-model printer driver is developed and introduced into the market. However, specifications of models that are introduced into the market after the introduction of the all-model printer driver are new to the all-model printer driver. The all-model printer driver may not necessarily fully support the functions and prohibition rule of a new model. The continuous use of the all-model printer driver with the new model may possibly inconvenience the user.

For example, when the all-model printer driver is developed, information on the prohibition rule of a new image processing apparatus 250 is not publicly available. A print setting that violates the prohibition rule may be set on the user terminal. Only when the user comes up to the image processing apparatus 250 to collect resulting printed matter, he or she may be aware of the prohibition rule.

To be aware prior to the printing that the print setting violates the prohibition rule, the user is forced to install a printer driver that supports the prohibition rule of the new image processing apparatus 250.

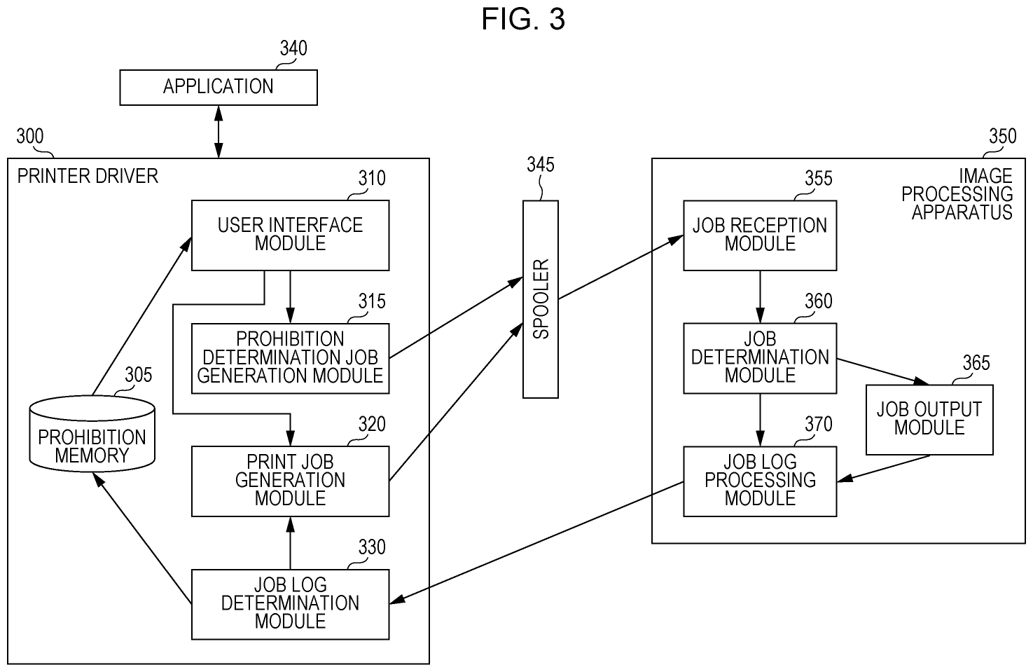

FIG. 3 illustrates a specific modular configuration of the exemplary embodiment. A printer driver 300 includes a prohibition memory 305, user interface module 310, prohibition determination job generation module 315, print job generation module 320, and job log determination module 330. The printer driver 300 is connected to an application 340, spooler 345, and image processing apparatus 350. The printer driver 300 corresponds to a module group that fulfills the functions of the information processing apparatus 100 described above. The image processing apparatus 350 corresponds to the image processing apparatus 150 described above. The image processing apparatus 350 includes a job reception module 355, job determination module 360, job output module 365, and job log processing module 370.

The application 340 is connected to the printer driver 300. The application 340 transfers a document to be printed to the printer driver 300. The application 340 may include a document generation program and/or a web browser. When the print operation is performed by using the application 340, a print dialog on the application 340 is used to display a user interface on the user interface module 310 in a specified printer driver 300.

The user interface module 310 is connected to the prohibition memory 305, the prohibition determination job generation module 315, and the print job generation module 320. For the print operation on the image processing apparatus 350, the user interface module 310 displays a print setting screen that receives a print setting from the user. The user interface module 310 transfers the print setting to one of the prohibition determination job generation module 315 and the print job generation module 320. If a print execution instruction is provided, the user interface module 310 transfers to the print job generation module 320 the print setting obtained when the print execution instruction is provided. If a prohibition determination instruction is provided or each time when the print setting is made at each item thereof, the user interface module 310 transfers to the prohibition determination job generation module 315 the print setting obtained when the prohibition determination instruction is provided or each time when the print setting is made at each item thereof. Even if the print execution instruction is provided, the user interface module 310 transfers to the prohibition determination job generation module 315 the print setting obtained when the print execution instruction is provided. After receiving a determination result indicating that the prohibition determination job is in a printable status, the user interface module 310 may transfer the print setting to the print job generation module 320.

The prohibition determination job generation module 315 is connected to the user interface module 310 and the spooler 345. The prohibition determination job generation module 315 generates the prohibition determination job that reflects the print setting received by the user interface module 310 and transmits the prohibition determination job to the image processing apparatus 350 via the spooler 345.

The spooler 345 is connected to the prohibition determination job generation module 315 and the print job generation module 320 in the printer driver 300 and the job reception module 355 in the image processing apparatus 350. The spooler 345 receives the prohibition determination job from the prohibition determination job generation module 315 and the print job from the print job generation module 320 and temporarily stores the received prohibition determination job and print job. The image processing apparatus 350 performs successively the prohibition determination job and print job stored on the spooler 345. Specifically, if a print operation is in progress on the image processing apparatus 350, the image processing apparatus 350 stores the received prohibition determination job and print job. After completing the print operation, the image processing apparatus 350 performs the prohibition determination job and print job.

The job reception module 355 is connected to the spooler 345 and the job determination module 360. Via the spooler 345, the job reception module 355 receives the prohibition determination job from the prohibition determination job generation module 315 in the printer driver 300 and the print job from the print job generation module 320 in the printer driver 300 and then transfers the prohibition determination job and print job to the job determination module 360.

The job determination module 360 is connected to the job reception module 355, the job output module 365, and the job log processing module 370. If a job received from the job reception module 355 is a print job, the job determination module 360 transfers the print job to the job output module 365. If a job received from the job reception module 355 is a prohibition determination job, the job determination module 360 determines whether the print job is in a printable status on the image processing apparatus 350 in accordance with the print setting included in the prohibition determination job. The job determination module 360 then transfers the determination result to the job log processing module 370.

The job output module 365 is connected to the job determination module 360 and the job log processing module 370. The job output module 365 performs a print operation in accordance with the print job received from the job determination module 360. Specifically, the print job includes an image to be printed and a print setting. The job output module 365 prints the image in accordance with the print setting. The job output module 365 transfers to the job log processing module 370 log data representing a log of the print operation.

The job log processing module 370 is connected to the job log determination module 330 in the printer driver 300 and the job determination module 360, and the job output module 365. The job log processing module 370 stores the determination result of the prohibition determination job performed by the job determination module 360 and the log data of the print operation from the job output module 365. The determination result of the prohibition determination job and the log data of the print operation are set to be open such that the job log determination module 330 in the printer driver 300 read these data. Specifically, a memory portion storing the determination result of the prohibition determination job and the log data of the print operation is set to be accessible by the job log determination module 330. Alternatively, the determination result of the prohibition determination job and the log data of the print operation may be transmitted to the job log determination module 330 in the printer driver 300. Specifically, the determination result of the prohibition determination job and the log data of the print operation are transmitted to the printer driver 300 in accordance with a communication protocol between the printer driver 300 and the image processing apparatus 350.

The job log determination module 330 is connected to the job log processing module 370 in the image processing apparatus 350 and the prohibition memory 305, the print job generation module 320 in the printer driver 300. The job log determination module 330 acquires from the job log processing module 370 the determination result of the prohibition determination job and the log data of the print operation and stores the acquired data onto the prohibition memory 305. The determination result is responsive to the prohibition determination job transmitted from the prohibition determination job generation module 315. When determination result is stored on the prohibition memory 305, the determination is specified as being a combination of printable settings or a combination of non-printable settings.

The prohibition memory 305 is connected to the user interface module 310 and the job log determination module 330. The prohibition memory 305 corresponds to the memory 105 and stores the determination result of the prohibition determination job that the prohibition determination job generation module 315 has transmitted to the image processing apparatus 350. Specifically, if the determination result of the prohibition determination job is a combination of the sheet size A5 and the stapler operation and is determined to be in a non-printable status, the combination of the sheet size A5 and the stapler operation is stored as being in a non-printable status (namely, prohibited). If the print setting of the prohibition determination job is a combination of the sheet size A4 and the stapler operation and is determined to be printable, the combination of the sheet size A4 and the stapler operation is stored as being in a printable status.

The print job generation module 320 is connected to the user interface module 310, the job log determination module 330, and the spooler 345. The print job generation module 320 generates a print job that reflects the print setting received by the user interface module 310 and transmits the print job to the image processing apparatus 350 via the spooler 345.

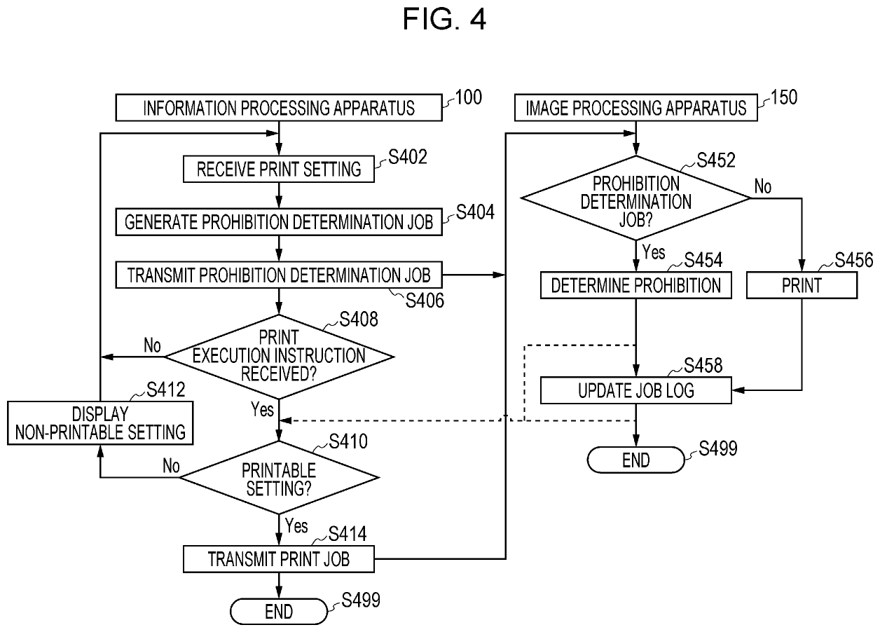

FIG. 4 is a flowchart illustrating a process of the exemplary embodiment. A left-hand side routine of the flowchart is part of the process performed by the information processing apparatus 100 and a right-hand side routine of the flowchart is part of the process performed by the image processing apparatus 150. In the process illustrated in the flowchart, the prohibition determination job is generated and transmitted if the print setting is received. If the print execution instruction is not received, the non-printable indication is not displayed regardless of the result of the prohibition determination. If the print execution instruction is received and the print setting is in a non-printable status, the non-printable indication is displayed.

In step S402, the information processing apparatus 100 detects a modification set by the user in each item of the setting.

In step S404, the information processing apparatus 100 generates the prohibition determination job at the print setting at the moment.

In step S406, the information processing apparatus 100 transmits the prohibition determination job to the image processing apparatus 150 and proceeds to step S452. In this case, the image processing apparatus 150 performs the prohibition determination in step S454.

In step S408, the information processing apparatus 100 determines whether the print execution instruction has been received in response to an operation of the user. If the print execution instruction has been received, the information processing apparatus 100 proceeds to step S410, or otherwise, the information processing apparatus 100 returns to step S402.

In step S452, the image processing apparatus 150 determines whether the job is a prohibition determination job. If the job is a prohibition determination job, the image processing apparatus 150 proceeds to step S454, or otherwise, the image processing apparatus 150 proceeds to step S456. In other words, in the case of a print job, the image processing apparatus 150 proceeds to step S456.

In step S454, the image processing apparatus 150 performs the prohibition determination on the print setting included in the prohibition determination job and proceeds to step S458. The image processing apparatus 150 may transmit the determination result obtained in step S454 to the information processing apparatus 100 and the information processing apparatus 100 may proceed to step S410.

In step S456, the image processing apparatus 150 performs the print operation in accordance with the print job.

In step S458, the image processing apparatus 150 updates the job log and proceeds to step S499. The image processing apparatus 150 may transmit the determination result obtained in step S454 to the information processing apparatus 100 and the information processing apparatus 100 may proceed to step S410. The information processing apparatus 100 may proceed to step S410 immediately subsequent to step S454 or step S458.

The information processing apparatus 100 proceeds to step S414 if the print setting at the prohibition determination job transmitted in step S406 is in a printable status in step S410, or otherwise, the information processing apparatus 100 proceeds to step S412. The operation in step S410 is performed if the determination result in step S408 is yes branch (namely, if the print execution instruction has been received) and after the determination result has been received from the image processing apparatus 150.

In step S412, the information processing apparatus 100 displays an indication indicating that the current setting is a non-printable setting. The information processing apparatus 100 returns to step S402.

in step S414, the information processing apparatus 100 generates a print job and transmits the generated print job to the image processing apparatus 150. In such a case, the image processing apparatus 150 performs the print operation in step S456.

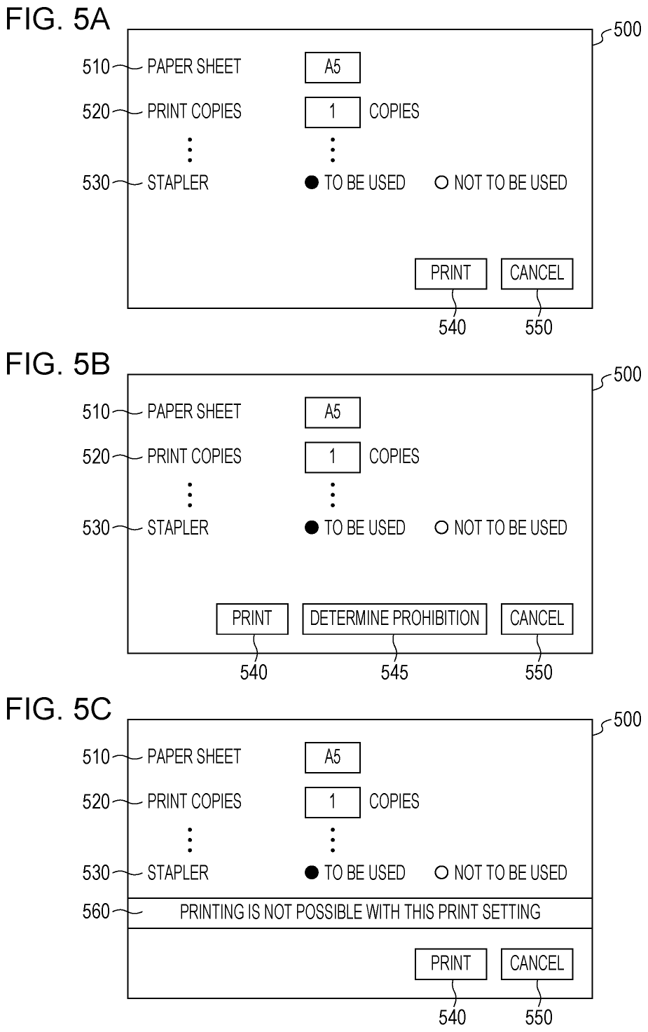

FIGS. 5A through 5C illustrate on-screen display examples related to a print setting of the exemplary embodiment. A screen 500 is a print setting screen that receives an operation of the user and is displayed on a display of the information processing apparatus 100.

The screen 500 illustrated in FIG. 5A includes a paper sheet setting region 510, copy count setting region 520, stapler operation setting region 530, print button 540, and cancel button 550.

The generation of the prohibition determination job and the transmission of the prohibition determination job to the image processing apparatus 150 are triggered when the user selects a print button 540 or when one item of the print setting is modified. When the print button 540 is selected, and if the determination result of the prohibition determination job indicates a printable setting, the print job is generated and transmitted to the image processing apparatus 150.

As illustrated in FIG. 5B, the generation and transmission of the prohibition determination job to the image processing apparatus 150 may be triggered when the user selects a prohibition determination button 545.

The screen 500 displays the paper sheet setting region 510, copy count setting region 520, stapler operation setting region 530, print button 540, prohibition determination button 545, and cancel button 550.

When the determination result of the prohibition determination job is received from the image processing apparatus 150, a prohibition determination result screen region 560 may be displayed as illustrated in FIG. 5C.

The screen 500 displays the paper sheet setting region 510, copy count setting region 520, stapler operation setting region 530, print button 540, cancel button 550, and prohibition determination result screen region 560.

If the determination result of the prohibition determination job is non-printable, a message reading “Printing is not possible with this setting” is displayed on the prohibition determination result screen region 560.

If the determination result of the prohibition determination job is printable, a message reading “Printing is now starting with the print setting on the image processing apparatus 150” may be displayed on the prohibition determination result screen region 560 after the print job is transmitted to the image processing apparatus 150. Alternatively, the user interface of the print setting on the screen 500 may be closed.

FIG. 5C illustrates the on-display example when the determination result of the prohibition determination job has been received on the screen 500 in FIG. 5A. In addition, the prohibition determination result screen region 560 may be added to the screen 500 in FIG. 5B.

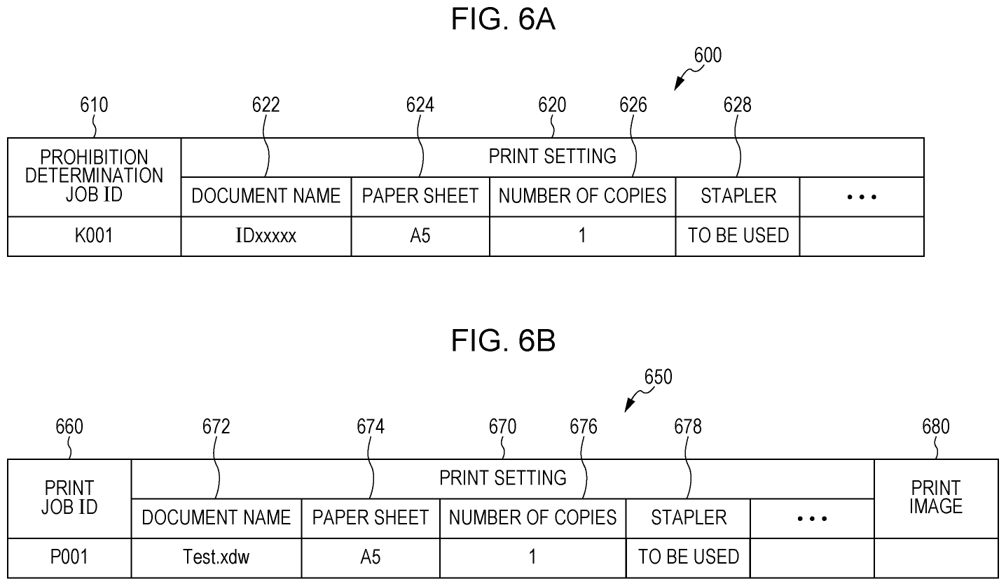

FIG. 6A illustrates an example of a data structure of prohibition determination job information 600. The prohibition determination job information 600 is generated by the prohibition determination job transmission module 114.

The prohibition determination job information 600 includes a prohibition determination job identification (ID) column 610 and a print setting column 620. The print setting column 620 includes a document name sub-column 622, paper sheet sub-column 624, copy count sub-column 626, and stapler operation sub-column 628. In accordance with the exemplary embodiment, the prohibition determination job ID column 610 stores information uniquely identifying the prohibition determination job (specifically, a prohibition determination job ID). The print setting column 620 stores a print setting. The document name sub-column 622 stores the document name of a document serving as a print target. The paper sheet sub-column 624 stores the type of a paper sheet set in the print setting. The copy count sub-column 626 stores a copy count set in the print setting. The stapler operation sub-column 628 stores information as to whether the stapler operation is to be performed or not. The print setting column 620 equals a print setting column 670 of print job information 650 in FIG. 6B.

For example, prohibition determination job ID: K001 indicates the print setting including the document ID “ID xxxxx”, paper sheet “A5”, copy count “1”, and stapler operation “to be used”.

The prohibition determination job ID is generated by the information processing apparatus 100. The determination result acquired by the determination result acquisition module 116 corresponding to the prohibition determination job transmitted from the prohibition determination job transmission module 114 is identified by including the prohibition determination job ID in the prohibition determination job information 600 and by including the prohibition determination job ID in the determination result of the image processing apparatus 150. More specifically, a determination is made as to whether the prohibition determination job ID in the determination result acquired by the determination result acquisition module 116 matches the prohibition determination job ID of the prohibition determination job transmitted from the prohibition determination job transmission module 114. If the two IDs match each other, the determination result acquired by the determination result acquisition module 116 is a determination result for the prohibition determination job transmitted from the prohibition determination job transmission module 114.

FIG. 6B illustrates a data structure of a print job information 650. Specifically, FIG. 6B illustrates the print job information 650 generated by the print job transmission module 112.

The print job information 650 includes a print job ID column 660, print setting column 670, and print image column 680. The print setting column 670 includes a document name sub-column 672, paper sheet sub-column 674, print count sub-column 676, and stapler operation sub-column 678. In accordance with the exemplary embodiment, the print job ID column 660 stores information uniquely identifying a print job (specifically, a prohibition determination job ID). The print setting column 670 stores a print setting. The document name sub-column 672 stores the document name of a document serving as a print target. The paper sheet sub-column 674 stores the type of a paper sheet set in the print setting. The copy count sub-column 676 stores a copy count set in the print setting. The stapler operation sub-column 678 stores information as to whether the stapler operation is to be performed or not. The print image column 680 stores a print image of a document serving as a print target.

For example, print job ID: P001 indicates the print setting including the document name “Test xdw”, paper sheet “A5”, copy count “1”, and stapler operation “to be used”. The print image column 680 stores a print image.

FIGS. 6A and 6B illustrate the prohibition determination job information 600 and the print job information 650 in a separate form. A column listing information (called a flag) indicating whether the job is a prohibition determination job or a print job may be added to the print job information 650. Specifically, information on a job type may be listed at printer job language (PJL).

If the job is a prohibition determination job, the print image may not necessarily be stored in the print image column 680 to reduce an amount of transmission data. Further, if the job is a prohibition determination job, the prohibition determination job ID may be used as the document name of the document.

As described above, if the print button 540 is selected and the prohibition determination job is transmitted to the image processing apparatus 150, the print image may be stored in the print image column 680. Further, if the determination result of the prohibition determination job is in a printable status, the image processing apparatus 150 may print the print image without newly receiving the print job. In such a case, the prohibition determination job also serves as a print job. If the determination result of the prohibition determination job is non-printable, the image processing apparatus 150 discards the print image in the print image column 680. The discarding also means the deletion of the print image.

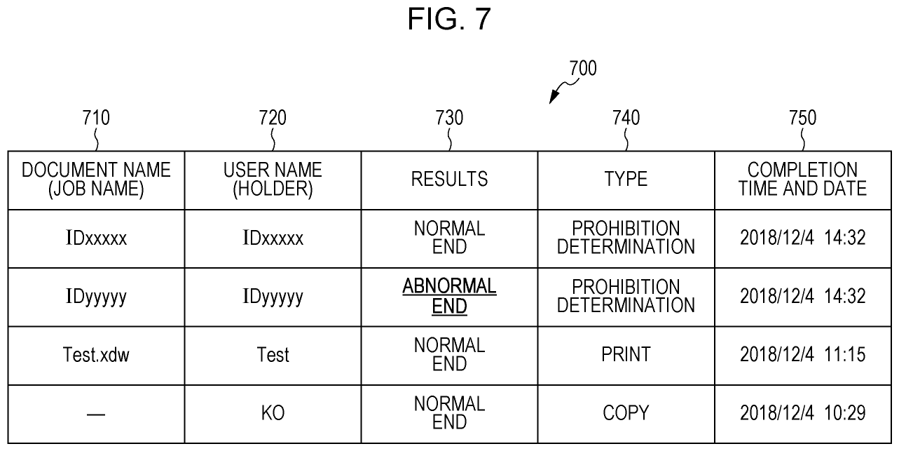

The job log processing module 370 in the image processing apparatus 350 generates a print and prohibition determination job log table 700. FIG. 7 illustrates a data structure of the print and prohibition determination job log table 700.

The print and prohibition determination job log table 700 includes a document name (job name) column 710, user name (holder name) column 720, result column 730, type column 740, and completion time and date column 750. The document name column 710 stores a document name (or a job name). The user name (holder name) column 720 stores a user name (or holder name). The type column 740 stores results. Specifically, in accordance with the exemplary embodiment, for the print job, the type column 740 lists “normal end” that indicates that the print operation has normally ended or “abnormal end” that indicates that the print operation has abnormally ended and for the prohibition determination job, the type column 740 lists “normal end” that indicates that the print operation is in a printable status in the print setting of the prohibition determination job or “abnormal end” that indicates that the print operation is in a non-printable status in the print setting of the prohibition determination job. The type column 740 stores the type of the job. Specifically, in accordance with the exemplary embodiment, the type column 740 lists prohibition determination indicating a prohibition determination job, print indicating the print job, or copy indicating the print operation. The completion time and date column 750 stores time and date when the job has completed (year, month, day, hours, minutes, seconds, and sub-second or a combination thereof).

The first row of the print and prohibition determination job log table 700 identified by the document name (job name) IDxxxxx indicates a user name (holder name) “IDxxxxx”, result “normal end”, type “prohibition determination”, and completion time and date “2018/12/4 14:32”. The second row of the print and prohibition determination job log table 700 identified by a document name (job name) IDyyyyy indicates a user name (holder name) “IDyyyyy”, result “abnormal end”, type “prohibition determination”, and completion time and date “2018/12/4 14:32”. The third row of the print and prohibition determination job log table 700 identified by a document name (job name) “Test xdw” indicates a user name (holder name) “Test”, result “normal end”, type “print”, and completion time and date “2018/12/4 11:15”. The fourth row of the print and prohibition determination job log table 700 identified by a document name (job name) “-” indicates a user name (holder name) “KO”, result “normal end”, type “copy”, and completion time and date “2018/12/4 10:29”.

The determination result acquisition module 116 accesses the print and prohibition determination job log table 700 stored on the image processing apparatus 150 and reads the determination result of the prohibition determination job transmitted from the prohibition determination job transmission module 114.

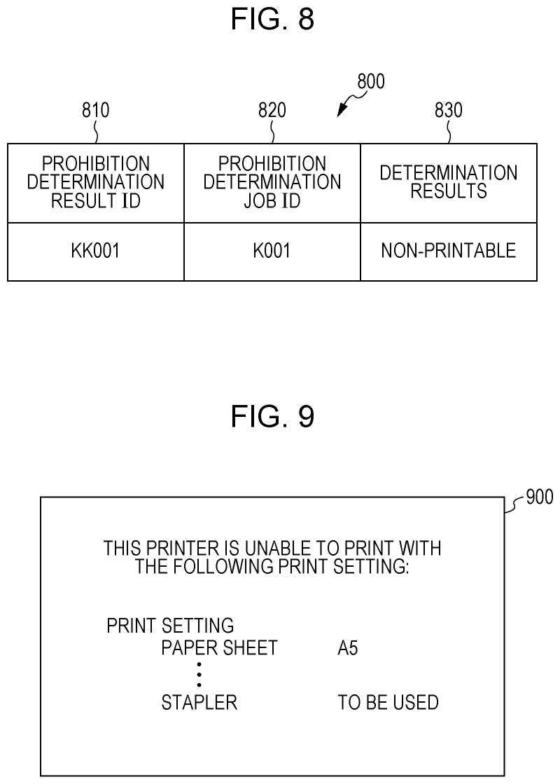

The determination result transmission module 166 may transmit prohibition determination result information 800 to the information processing apparatus 100. FIG. 8 illustrates the data structure of the prohibition determination result information 800.

The prohibition determination result information 800 includes a prohibition determination result ID column 810, prohibition determination job ID column 820, and determination result column 830. In accordance with the exemplary embodiment, the prohibition determination result ID column 810 stores information uniquely identifying a prohibition determination result (specifically, a prohibition determination result ID). The prohibition determination job ID column 820 stores a prohibition determination job ID. The determination result column 830 stores the determination result of the prohibition determination job.

For example, the prohibition determination result information 800 in FIG. 8 identified by a prohibition determination result ID KK001 lists a prohibition determination job ID “K001” and the prohibition determination job being in a non-printable status.

Based on the determination result received by the determination result acquisition module 116, the display controller 132 may display a screen 900 in place of the display example in FIG. 5C. FIG. 9 illustrates the display example of the prohibition determination result of the exemplary embodiment.

For example, the screen 900 displays a message reading “This printer is unable to print with the following print setting”, and the print setting is “Paper sheet: A5, . . . , Stapler: To be used”.

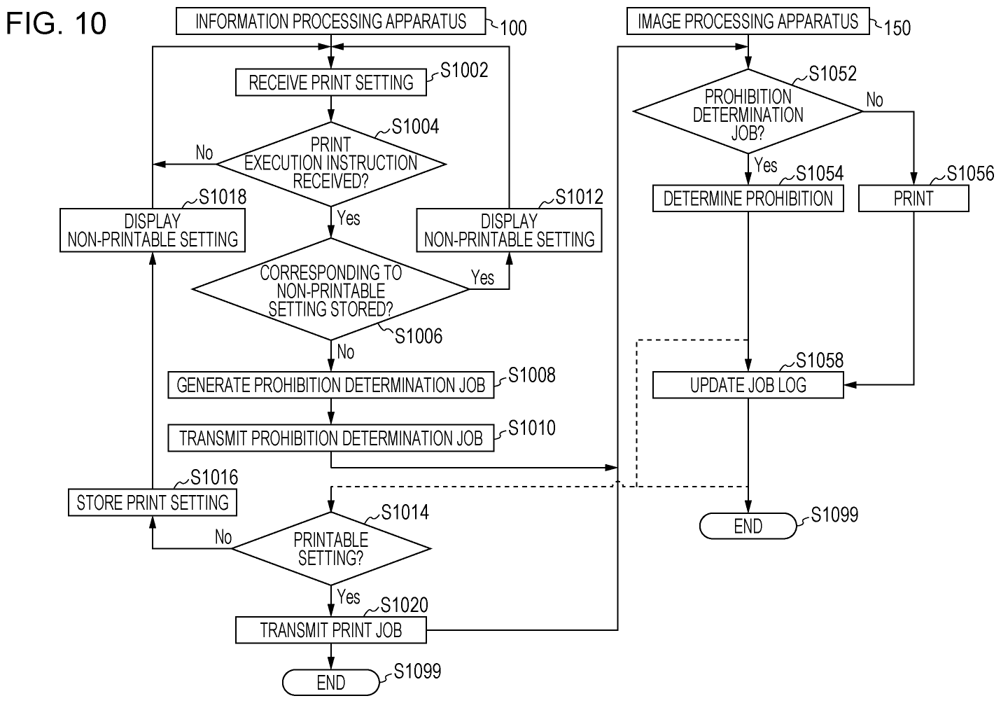

FIG. 10 illustrates a flowchart of a process of the exemplary embodiment. The information processing apparatus 100 alone may perform the prohibition determination by using the memory 105 storing the prohibition determination result obtained by the image processing apparatus 150, without transmitting the prohibition determination job to the image processing apparatus 150.

The flowchart in FIG. 10 is different from the flowchart in FIG. 4. If the print execution instruction is received in the process of FIG. 10, the prohibition determination job is transmitted prior to the transmission of the print job, and the print setting and the determination result are stored. The rest of the process in FIG. 10 is identical to the process in FIG. 4. In the process of the flowchart in FIG. 4, the prohibition determination job and the determination result are exchanged in the background. In the process of the flowchart in FIG. 10, the prohibition determination job is transmitted after the print execution instruction is received, and a determination as to whether the print setting stored is in a printable status or not is made based on the stored detail of the print setting. If the determination has been complete by referring to the stored detail, the transmission of the prohibition determination job may not be performed. A left-hand side routine of the flowchart is part of the process performed by the information processing apparatus 100 and a right-hand side routine of the flowchart is part of the process performed by the image processing apparatus 150.

In step S1002, the information processing apparatus 100 receives each item of the print setting set by the user.

In step S1004, the information processing apparatus 100 determines whether a print execution instruction has been received in response to an operation of the user. If the print execution instruction has been received, the information processing apparatus 100 proceeds to step S1006, or otherwise, the information processing apparatus 100 returns to step S1002.

In step S1006, the information processing apparatus 100 determines whether the setting corresponds to the non-printable setting stored on the memory 105. If the setting corresponds to the non-printable setting, the information processing apparatus 100 proceeds to step S1012, or otherwise, the information processing apparatus 100 proceeds to step S1008.

In step S1008, the information processing apparatus 100 generates the prohibition determination job with the current print setting.

In step S1010, the information processing apparatus 100 transmits the prohibition determination job to the image processing apparatus 150 and the image processing apparatus 150 proceeds to step S1052. In such a case, the image processing apparatus 150 performs the prohibition determination in step S1054.

In step S1012, the information processing apparatus 100 displays an indication indicating that the information processing apparatus 100 is unable to perform the print operation with the setting effective when the print execution instruction has been received. The information processing apparatus 100 returns to step S1002.

In step S1052, the image processing apparatus 150 determines whether the job is a prohibition determination job. If the job is a prohibition determination job, the image processing apparatus 150 proceeds to step S1054, or otherwise, the image processing apparatus 150 proceeds to step S1056.

In step S1054, the image processing apparatus 150 performs the determination operation in accordance with the print setting included in the prohibition determination job and then proceeds to step S1058. Also in step S1054, the image processing apparatus 150 may transmit the determination result obtained in step S1054 to the information processing apparatus 100 and the information processing apparatus 100 may proceed to step S1014.

In step S1056, the image processing apparatus 150 performs the print operation in accordance with the print job.

In step S1058, the image processing apparatus 150 updates a job log and proceeds to step S1099. The image processing apparatus 150 may transmit the determination result obtained in step S1054 and the information processing apparatus 100 may proceed to step S1014. The information processing apparatus 100 proceeds to step S1014 immediately subsequent to step S1054 or step S1058.

In step S1014, the information processing apparatus 100 determines whether the print setting in the prohibition determination job transmitted in step S1010 is in a printable status. If the print setting is determined to be in a printable status, the information processing apparatus 100 proceeds to step S1020, or otherwise, the information processing apparatus 100 proceeds to step S1016. Specifically, the information processing apparatus 100 receives the determination result of the prohibition determination that the image processing apparatus 150 has performed in step S1054 and determines whether the setting is in a printable status.

In step S1016, the print setting determined to be in a non-printable status is stored and the information processing apparatus 100 proceeds to step S1018.

In step S1018, the information processing apparatus 100 displays an indication indicating that the information processing apparatus 100 is unable to perform the print operation with the setting obtained when the print execution instruction is received. The information processing apparatus 100 then returns to step S1002.

In step S1020, the information processing apparatus 100 generates a print job and transmits the print job to the image processing apparatus 150. In this case, the image processing apparatus 150 performs the print operation in step S1056.

The information processing apparatus 100 may be designed not to receive, in step S1002, the print setting determined to be in a non-printable status and stored in S1016. In such a case, the operation in step S1006 is dispensed with.

In step S1016, the print setting determined to be in a non-printable status is stored and the print setting determined to be in a printable status may also be stored. If the print setting corresponds to a printable setting in step S1006, the information processing apparatus 100 may proceed to step S1020 (namely, without generating and transmitting a prohibition determination job) rather than proceeding to step S1008. The information processing apparatus 100 may thus transmit the print job to the image processing apparatus 150. In other words, a prohibition determination job may be generated and then transmitted only for a print setting for which a prohibition determination job has neither been generated nor been transmitted.

The information processing apparatus 100 may display a job log. The display destination of the job log may be a display of the information processing apparatus 100 or may be a web browser of the information processing apparatus 100.

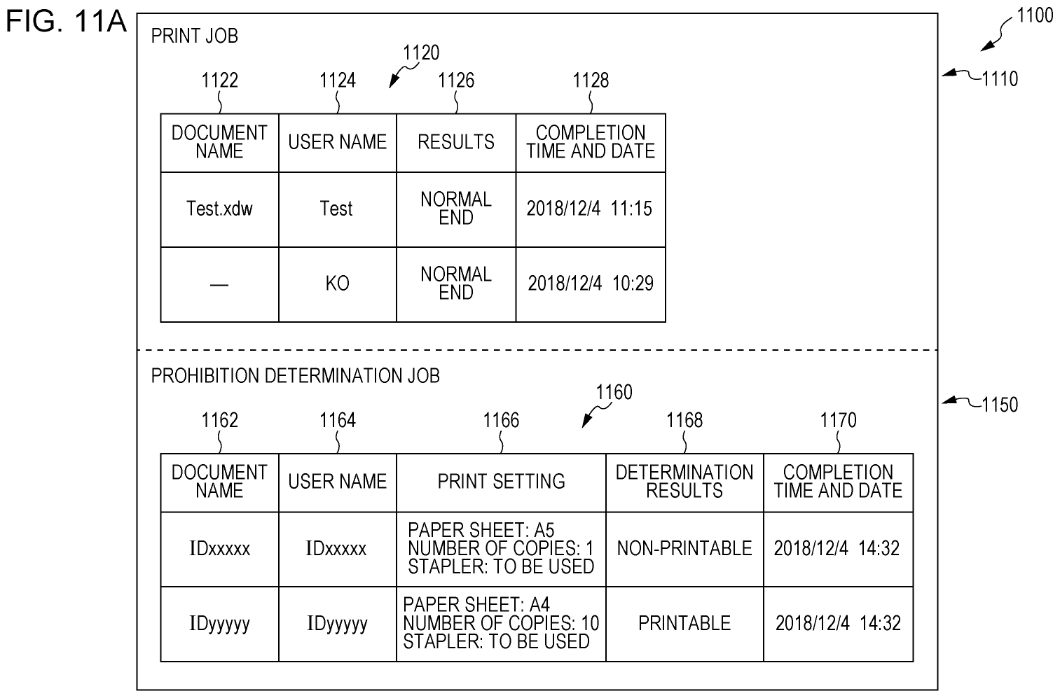

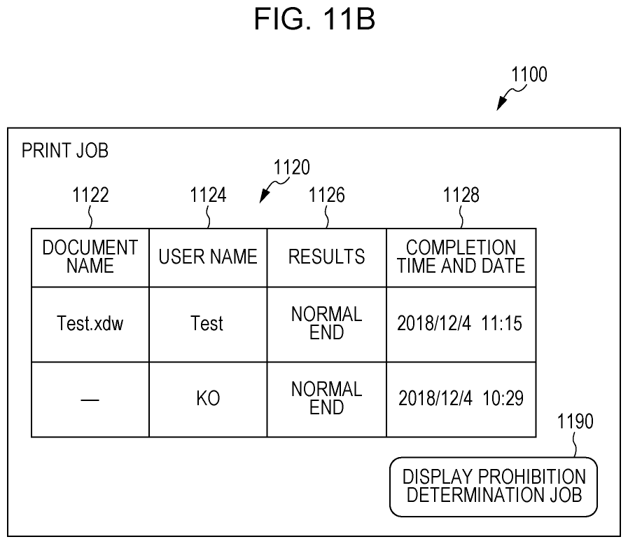

FIGS. 11A and 11B illustrate on-screen display examples of the job log of the exemplary embodiment.

Referring to FIG. 11A, the job log indicating process result of the print job and the job log indicating the determination result of the prohibition determination job may be separately displayed.

A screen region 1100 is split into a print job screen region 1110 on the top side thereof and a prohibition determination job screen region 1150 on the bottom side thereof.

The print job screen region 1110 displays a print job result table 1120. The print job result table 1120 includes a document name column 1122, user name column 1124, result column 1126, completion time and date column 1128. The document name column 1122 displays a document name. The user name column 1124 display a user name. The result column 1126 displays results of a print operation. The completion time and date column 1128 displays completion time and date.

The prohibition determination job screen region 1150 displays a prohibition determination job result table 1160. The prohibition determination job result table 1160 includes a document name column 1162, user name column 1164, print setting column 1166, determination result column 1168, completion time and date column 1170. The document name column 1162 displays a document name. The user name column 1164 displays a user name. The print setting column 1166 displays a print setting. The determination result column 1168 displays a determination result. The completion time and date column 1170 displays completion time and date.

Referring to FIG. 11B, only the job log representing the determination result of the print job is displayed. Specifically, the job log representing the prohibition determination job is not displayed.

A screen 1100 displays a print job result table 1120 and a prohibition determination job display button 1190. The print job screen region 1110 is identical to the print job result table 1120 displayed within the print job screen region 1110 in FIG. 11A. If the prohibition determination job display button 1190 is selected by the user, the prohibition determination job result table 1160 within the prohibition determination job screen region 1150 in FIG. 11A is displayed in place of the print job result table 1120.

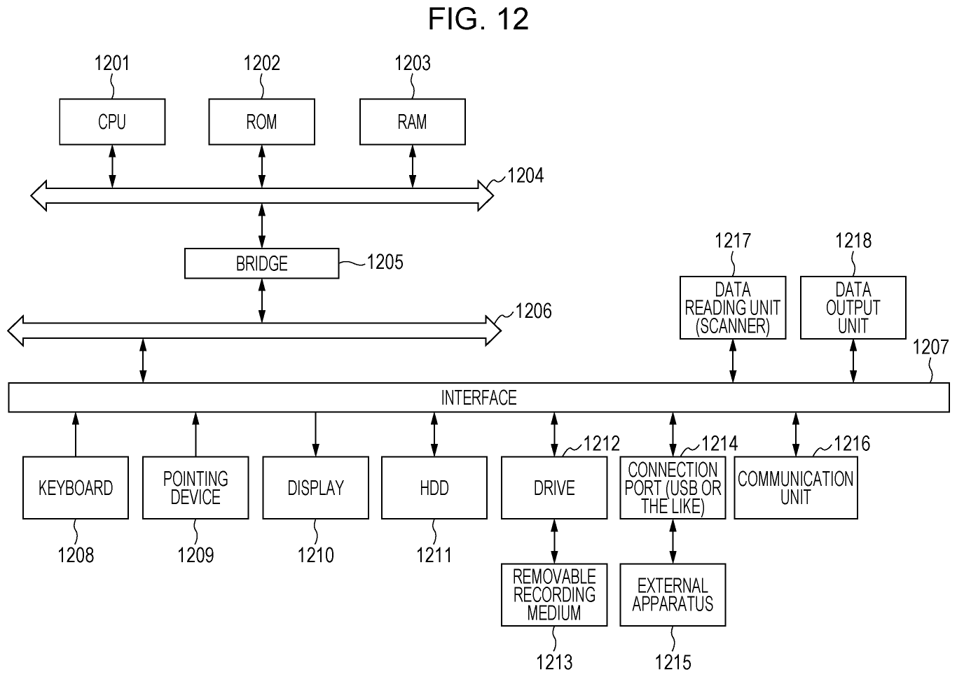

Referring to FIG. 12, the hardware configuration of each of the information processing apparatus 100, the image processing apparatus 150, the printer driver 300, and the image processing apparatus 350 of the exemplary embodiment is described below. The hardware configuration illustrated in FIG. 12 may be implemented by a personal computer. The hardware configuration includes a data reading unit 1217, such as a scanner, and a data output unit 1218.

A central processing unit (CPU) 1201 is a controller that executes the sequence of the above-described variety of modules in accordance with a computer program. The modules include the communication module 110, print job transmission module 112, prohibition determination job transmission module 114, determination result acquisition module 116, reception module 120, print setting reception module 122, prohibition determination instruction reception module 124, display processing module 130, display controller 132, display 134, communication module 160, print job reception module 162, prohibition determination job reception module 164, determination result transmission module 166, output module 170, display processing module 180, display controller 182, display 184, determination module 190, application 340, spooler 345, user interface module 310, prohibition determination job generation module 315, print job generation module 320, job log determination module 330, job reception module 355, job determination module 360, job output module 365, and job log processing module 370.

A read-only memory (ROM) 1202 stores a program and calculation parameters used by the CPU 1201. A random-access memory (RAM) 1203 stores the program used by the CPU 1201, and parameters that appropriately vary in the execution of the program. A host bus 1204 including a CPU bus interconnects these elements.

The host bus 1204 is connected via a bridge 1205 to an external bus 1206, such as a peripheral component interconnect/interface (PCI) bus.

A pointing device 1209, such as a keyboard 1208 or a mouse, is operated by the user. A display 1210 includes a liquid-crystal display device or a cathode ray tube (CRT) and displays a variety of information including image information and/or text information. A touch screen that performs the functions of both the pointing device 1209 and the display 1210 may be used. In such a case, the function of the keyboard 1208 may be implemented by drawing a software keyboard or a screen keyboard on a screen (such as a touch screen) without using the keyboard 1208 that is physically connected.

A hard disk drive (HDD) 1211 includes and drives a hard disk and records or reproduces the program executed by the CPU 1201 and information. The HDD 1211 may be a flash memory. The HDD 1211 implements the functions of the memory 105, the memory 155, and the prohibition memory 305. The HDD 1211 also stores a variety of data and a variety of computers programs.

A drive 1212 reads data or a program stored on a removable recording medium 1213, such as a magnetic disk, optical disk, magneto-optical disk, or semiconductor memory. The device 1212 transfers the data and program to the RAM 1203 connected thereto via an interface 1207, external bus 1206, bridge 1205, and host bus 1204. The removable recording medium 1213 may be used as a data recording region.

A connection port 1214 connects to an external apparatus 1215 and includes a universal serial bus (USB) port and IEEE 1394 port. The connection port 1214 is connected to the CPU 1201 via the interface 1207, external bus 1206, bridge 1205, host bus 1204 and the like. A communication unit 1216 is connected to a communication network and performs a data communication process. The data reading unit 1217 may be a scanner and reads a document. The data output unit 1218 may be a printer and performs a document output process.

The computer program of the exemplary embodiment is installed on a hardware system and software and hardware resources cooperate with each other to implement the exemplary embodiment.

The hardware configuration, such as that of the information processing apparatus 100, in FIG. 12 is a configuration example only. The exemplary embodiment is not limited to this hardware configuration of FIG. 12 and may be acceptable in any form as long as the modules of the exemplary embodiment are implemented. For example, some modules may be implemented by using dedicated hardware (such as an application specific integrated circuit (ASIC)) or a reconfigurable integrated circuit (such as field-programmable gate array (FPGA)). In another example, some modules may be in an external system and connected to the system of FIG. 12 via a communication network. In yet another example, plural systems of FIG. 12 may be interconnected to each other via a communication line such that the systems operate in concert with each other. One of the modules may be incorporated not only in a personal computer, but also in a mobile information communication terminal, network home appliance, robot, copying machine, facsimile device, scanner, printer, or multi-function apparatus.

Prior to the reception of a print setting, the information processing apparatus 100 may generate as a prohibition determination job a combination of print settings that are settable, may ask the image processing apparatus 150 about the prohibition determination job, and may store the determination result responsive to the prohibition determination job on the memory 105. The prohibition determination job may be generated for each of all the print settings that are settable. For example, a new image processing apparatus 150 may now be connected and a new post-processing unit that performs a stapler operation may be added to the image processing apparatus 150. In such a case, the following operations may be performed.

(1) An “all-prohibition generation button” that is used to perform a process to generate all prohibition rules is arranged as a user interface, and the selection of the button is detected if the button is selected.

(2) The information processing apparatus 100 asks the image processing apparatus 150 about all combinations of the print settings. Specifically, all combinations of the print settings are generated, and the prohibition determination job including each of the combinations is generated and sent to the image processing apparatus 150 for determination.

(3) The determination result of the prohibition determination job is obtained from the image processing apparatus 150 and a combination of print settings with the determination result thereof being in a non-printable status is stored on the memory 105 as prohibition data.

(4) If the prohibition data for a target model is stored on the memory 105, a determination as to whether the combination is in a printable status or not is made by using the prohibition data each time the print setting is modified. If the combination is determined to be in a non-printable status, the user may be alerted to the non-printable status.

The prohibition data stored on the memory 105 may be exported to a file. The file may be imported to another printer driver. The file may be stored on a server that has access to the information processing apparatus 100. Instead of the prohibition data on the memory 105, the information processing apparatus 100 may use the file on the server and determine whether the job is in a printable status with a combination of print settings specified by the user.

The above-described program may be supplied in a stored state on a recording medium. The program may also be provided via a communication medium. In such a case, the above-described program may be understood as the disclosure of a “non-transitory computer readable recording medium storing the program”.

The “non-transitory computer readable recording medium storing the program” refers to a computer readable recording medium storing the program, and is used to install the program, to execute the program, or to distribute the program.

The recording media include digital versatile disk (DVD), compact disk (CD), Blu-ray disk (registered trademark), magneto-optical disk (MO), flexible disk (FD), magnetic tape, hard disk, read-only memory (ROM), electronically erasable and programmable read-only memory (EEPROM (registered trademark)), flash memory, random-access memory (RAM), and secure digital (SD) memory card. The DVDs include “DVD-R, DVD-RW, and DVD-RAM” complying with the standard formulated by the DVD forum, and “DVD+R and DVD+RW” complying with DVD+RW. The CDs include read-only CD (CD-ROM), recordable CD-R, and rewritable CD-RW.

The program in whole or in part may be stored on the recording medium for storage and distribution. The program in whole or in part may be transmitted via a transmission medium. The transmission media include a wired network, a wireless network, or a combination thereof. The wired and wireless networks may include a local-area network (LAN), metropolitan-area network (MAN), wide-area network (WAN), the Internet, intranet, and/or extranet. The program in whole or in part may be transmitted over a carrier wave.

The program may be part of another program, or may be stored on the recording medium together with another program. The program may be split and split programs may then be separately stored on the recording media. The program may be processed in any fashion before being stored as long as the program remains restorable. For example, the program may be compressed or encrypted before storage.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising an information processing apparatus and an image processing apparatus,
wherein the information processing apparatus includes:
a receiving unit that receives a print setting;
a print job transmitting unit that, in response to a print execution instruction from a user, transmits to the image processing apparatus a print job that reflects the print setting;
a prohibition determination job transmitting unit that transmits to the image processing apparatus a prohibition determination job that reflects the print setting; and
a controller that performs control such that the print job reflecting the print setting is not transmitted if the print setting reflected in the prohibition determination job transmitted by the prohibition determination job transmitting unit is determined to be in a non-printable status, and
wherein the image processing apparatus includes:
an output unit that executes the print job received from the information processing apparatus; and
a determination unit that determines, in response to the prohibition determination job received from the information processing apparatus, whether the print setting reflected in the prohibition determination job is in a printable status.

2. An information processing apparatus comprising:
a receiving unit that receives a print setting;
a print job transmitting unit that, in response to a print execution instruction from a user, transmits to an image processing apparatus a print job that reflects the print setting;
a prohibition determination job transmitting unit that transmits to the image processing apparatus a prohibition determination job that reflects the print setting; and
a controller that performs control such that that the print job reflecting the print setting is not transmitted if the print setting reflected in the prohibition determination job transmitted by the prohibition determination job transmitting unit is determined to be in a non-printable status.

3. The information processing apparatus according to claim 2, wherein if the print execution instruction has been provided from the user, the controller performs control to cause the prohibition determination job transmitting unit to transmit the prohibition determination job before transmitting the print job reflecting the print setting, and if the print job is determined to be in a printable status, the controller performs control to transmit the print job reflecting the print setting to the image processing apparatus.

4. The information processing apparatus according to claim 2, further comprising a display controller that, if the print job is determined to be in a non-printable status, performs control to cause a display to display an indication indicating that the print job is in a non-printable status.

5. The information processing apparatus according to claim 3, further comprising a display controller that, if the print job is determined to be in a non-printable status, performs control to cause a display to display an indication indicating that the print job is in a non-printable status.

6. The information processing apparatus according to claim 2, further comprising:
a second receiving unit that receives a prohibition determination instruction from the user; and
a display controller that, if the prohibition determination instruction has been received by the second receiving unit, performs control to transmit to the image processing apparatus the prohibition determination job reflecting the print setting and to cause a display to display an indication that is based on a determination result of the prohibition determination job.

7. The information processing apparatus according to claim 2, wherein the prohibition determination job transmitting unit transmits to the image processing apparatus the prohibition determination job reflecting the print setting if the print setting has been received.

8. The information processing apparatus according to claim 7, further comprising a display controller that performs control to cause a display to display an indication indicating that the print job is in a non-printable status if the print execution instruction has been provided and the prohibition determination job that reflects the print setting responsive to the print execution instruction provided is determined to be in a non-printable status.

9. The information processing apparatus according to claim 8, wherein the display controller performs control to cause the display not to display the indication indicating the print job is in a non-printable status if the print execution instruction has not been provided and the transmitted prohibition determination job is determined to be in a non-printable status.

10. The information processing apparatus according to claim 2, further comprising a memory that stores a combination of the print setting reflected in the transmitted prohibition determination job and a determination result of the prohibition determination job.

11. The information processing apparatus according to claim 3, further comprising a memory that stores a combination of the print setting reflected in the transmitted prohibition determination job and a determination result of the prohibition determination job.

12. The information processing apparatus according to claim 4, further comprising a memory that stores a combination of the print setting reflected in the transmitted prohibition determination job and a determination result of the prohibition determination job.

13. The information processing apparatus according to claim 5, further comprising a memory that stores a combination of the print setting reflected in the transmitted prohibition determination job and a determination result of the prohibition determination job.

14. The information processing apparatus according to claim 6, further comprising a memory that stores a combination of the print setting reflected in the transmitted prohibition determination job and a determination result of the prohibition determination job.

15. The information processing apparatus according to claim 7, further comprising a memory that stores a combination of the print setting reflected in the transmitted prohibition determination job and a determination result of the prohibition determination job.

16. The information processing apparatus according to claim 10, wherein in accordance with the determination result stored on the memory, the receiving unit does not receive the print setting that is in a non-printable status.

17. The information processing system according to claim 1, wherein the image processing apparatus further comprises a memory that stores the print job received from the information processing apparatus, and
wherein the memory stores the print setting for the prohibition determination job received from the information processing apparatus and a determination result responsive to the prohibition determination job.

18. The information processing system according to claim 17, further comprising a display controller that performs control to cause a display to display information related to the print job stored on the memory,
wherein the display controller performs control to cause the display to display the information related to the print job and information related to the prohibition determination job in a separate form.

19. The information processing system according to claim 17, further comprising a display controller that performs control to cause a display to display information related to the print job stored on the memory,
wherein the display controller performs control to cause the display to display the information related to the print job but not to display information related to the prohibition determination job.

20. A non-transitory computer readable medium storing a program causing a computer to execute a process for processing information, the process comprising:
receiving a print setting;
in response to a print execution instruction from a user, transmitting to an image processing apparatus a print job that reflects the print setting;
transmitting to the image processing apparatus a prohibition determination job that reflects the print setting; and
performing control such that the print job reflecting the print setting is not transmitted if the print setting reflected in the transmitted prohibition determination job is determined to be in a non-printable status.
